(19) United States
(12) Patent Application Publication
(10) Pub. No.: US 2017/0124279 A1
(43) Pub. Date: May 4, 2017

(54) Adaptive Complimentary Self-Assessment And Automated Health Scoring For Improved Patient Care

(71) Applicant: Alive Sciences, LLC, Sarasota, FL (US)

(72) Inventor: Steven I. Rothman, Sarasota, FL (US)

(73) Assignee: ALIVE SCIENCES, LLC, Sarasota, FL (US)

(21) Appl. No.: 14/926,122

(22) Filed: Oct. 29, 2015

(51) Int. Cl. G06F 19/00; G06F 17/30

(52) U.S. Cl. CPC G06F 19/3431; G06F 19/322; G06F 17/3053

(57) ABSTRACT

Systems and methods can support adaptive self-assessment for automated health scoring. Medical data associated with a patient may be collected. Health queries may be issued to the patient. The patient can provide self-assessment data in response to the queries. A health score for the patient may be computed as a function of at least a portion of the received medical data and at least a portion of the self-assessment data. The health score may be visualized in one or more graphs. The health score may be transmitted to one or more caregivers. Medical alerts and patient recommendation may be generated in response to the health score. Content and frequency of future health queries may be adapted in response to the health score and in response to complimentary evaluation from one or more caregivers.

### BACKGROUND

Patients in hospitals are almost constantly monitored and attended to by nursing staff and technicians. Physicians and specialists also generally see the patients throughout the day. The various professionals interacting with such patients have numerous opportunities to observe and evaluate the progress of each patient. There are numerous challenges to providing such close health monitoring and evaluation to individuals in their homes, in assisted living, or even in nursing homes or hospice care. Inadequate monitoring of patients often results in unobserved, and thus uncorrected, declines in the condition of the patient. Such decline result in negative health outcomes, hospital (re)admissions, delayed recovery, complications, pain, discomfort, suffering, increased costs, and possibly death.

There is a need in the art for automated systems to monitor and evaluate the general overall health trends of a patient residing at home, in assisted living, or in a nursing facility. There is further need for such systems to adaptively query patients for self-reported information that may be incorporated into a trackable health score for evaluating progress, generating alerts, and establishing recommendations for transitions in the levels of monitoring and care.

### SUMMARY

In certain example embodiments described herein, methods and systems can support adaptive self-assessment for automated health scoring. Medical data associated with a patient may be collected. Health queries may be issued to the patient. The patient can provide self-assessment data in response to the queries. A health score for the patient may be computed as a function of at least a portion of the received medical data and at least a portion of the self-assessment data. The health score may be visualized in one or more graphs. The health score may be transmitted to one or more caregivers. Medical alerts and patient recommendation may be generated in response to the health score. Content and frequency of future health queries may be adapted in response to the health score and in response to complimentary evaluation from one or more caregivers.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a complimentary self-assessment health scoring system in accordance with one or more embodiments presented herein.

FIG. 2 is a block diagram illustrating a health score system in accordance with one or more embodiments presented herein.

FIG. 3 is a chart showing a health score graph in accordance with one or more embodiments presented herein.

FIG. 4 is a graph of an excess risk curve where an outcome measurement is a function of heart rate at discharge in accordance with one or more embodiments presented herein.

FIG. 5 is a graph of an excess risk curve where an outcome measurement is a function of creatinine at discharge in accordance with one or more embodiments presented herein.

FIG. 6 is a block flow diagram depicting a method for adaptive complimentary self-assessment for patient health scoring in accordance with one or more embodiments presented herein.

FIG. 7 is a block flow diagram depicting a method for assessing risk associated with at least one type of patient data due to deviation from normative values in accordance with one or more embodiments presented herein.

FIG. 8 is a block flow diagram depicting a method for determining an overall risk associated with the current health condition of a patient in accordance with one or more embodiments presented herein.

FIG. 9 is a block diagram depicting a computing machine and a module in accordance with one or more embodiments presented herein.

### DETAILED DESCRIPTION OF EXAMPLE EMBODIMENTS

### Overview

The methods and systems described herein enable adaptive complimentary self-assessment and automated health scoring. Monitoring and tracking the health and wellbeing of patients in their homes, assisted living, nursing homes, hospice care, rehabilitation centers, and other health facilities can be vital to identifying changes in health indicators. Certain changes in health indicators may indicate progress and recovery while certain other changes may precede catastrophic health events. Such monitoring and tracking may be particularly meaningful in the days and weeks immediately following discharge from a hospital or other care facility to ensure effective transition, reduce bad outcomes, and avoid readmissions. Such monitoring and tracing may also be useful near the transition points between levels of patient care such as prior and during the transition from patient home to nursing home or similar transition to hospice care.

Patient data may be collected from sensors, instruments, caregivers, or from self-assessed patient query responses. The self-assessed patient query responses may be made in response to patient queries. The patient queries may be presented to the patient using a computerized patient device (such as a tablet computer or smartphone). Alternatively, the patient queries may be administered using an automated voice call, telephone call, a television set-top box, or any other electronic device. The patient queries may be adaptively generated by an automated health score system. One or more human recipients may compliment operations of the automated health score system to generate the content or timing of the patient queries.

The functionality of various example embodiments will be explained in more detail in the following description to be read in conjunction with the figures illustrating system components and process flows. Turning now to the drawings, in which like numerals indicate like (but not necessarily identical) elements throughout the figures, example embodiments are described in detail.

### Example System Architectures

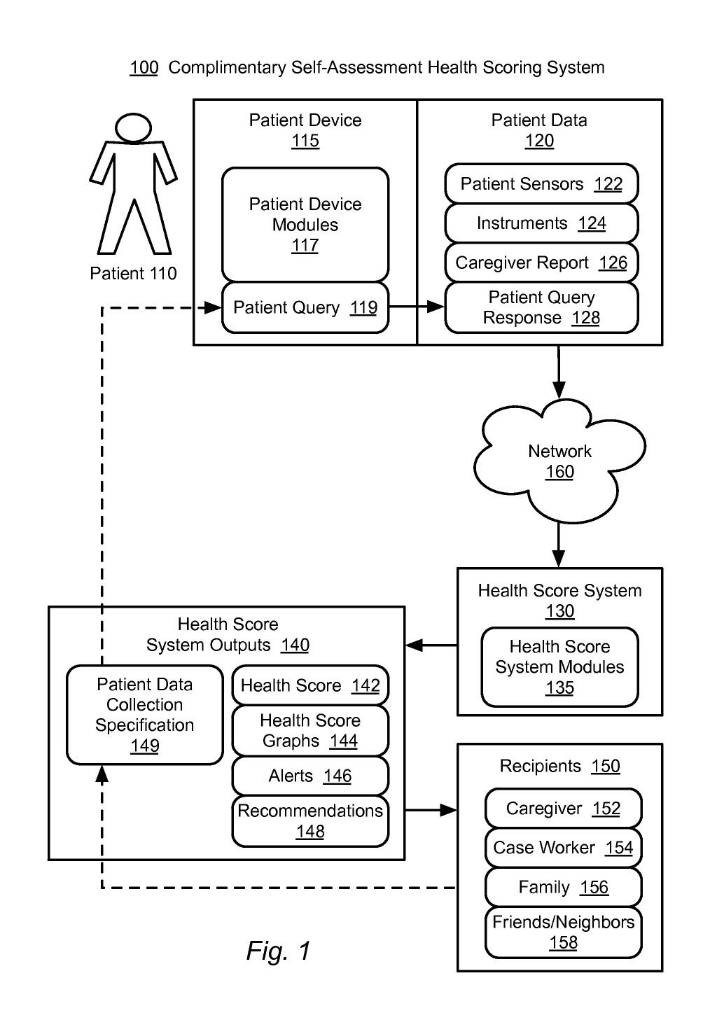

FIG. 1 is a block diagram depicting a complimentary self-assessment health scoring system 100, in accordance with certain exemplary embodiments. The complimentary self-assessment health scoring system 100 can collect and process patient data 120 related to a patient 110. The patient data 120, particularly patient query responses 128, may be obtained from patient queries 119. The patient queries 119 may be issued to the patient 110 through a patient device 115 executing one or more patient device modules 117. The patient data 120 may also be obtained from patient sensors 122, instruments 124, or other medical monitoring systems. The patient data 120 may also be obtained from caregiver reports 126.

The patient data 120 may be collected for processing by a health score system 130 executing one or more health score system modules 135. The health score system 130 may generate health score system outputs 140. The health score system outputs 140 may include health scores 142, health score graphs 144, alerts 146, and/or recommendations 148. The health score system outputs 140 may also include patient data collection specifications 149, which may then influence content, context, and/or timing of the patient queries 119.

Various recipients 150 of the health score system outputs 140 can include caregivers 152, case workers 154, family members 156, or friends/neighbors 158. The patient 110 may also be a direct recipient of the health score outputs 140. The recipients 150 may use the provided health score system outputs 140 to influence the patient data collection specification 149. Generation and refinement of the patient data collection specification 149 by both the health score system 130 and one or more of the recipients 150 may be referred to as a complimentary solution where machine intelligence and human intelligence compliment one another to address the challenges of patient monitoring and evaluation.

The patient 110 may be located in their home, independent living facility, retirement living facility, assisted living, hospice, nursing home, rehabilitation center, or some other such facility. The patient 110 may require or benefit from medical care or supervision in either an inpatient or outpatient setting. For example, the technology presented herein may support tracking the patient 110 after discharge from a facility or after a procedure. Such tracking may reduce incidences of readmission or poor outcomes. Self-assessment from the patient 110 may serve as partial input to the health score system 130. The health score system 130 may process the self-assessment inputs along with other inputs to generate health scores 142, health score graphs 144, alerts 146, and recommendations 148. Functionality of the health score system 130 may be complimented by feedback from one or more human recipients 150 of the health score system outputs 140.

The patient 110 may interface with the complimentary self-assessment health scoring system 100 via the patient device 115. The patient device 115 may be any type of computing machine including a smart phone, tablet computer, set-top box, desktop computer, laptop, or so forth. The patient device modules 117 may include an application, browser, or mobile application configured to support interfacing with the patient 110 via the patient device 115. Accordingly, patient queries 119 may be presented to the patient 110 via a user interface associated with a computing machine to obtain patient query responses 128.

Alternatively, the patient device 115 may be a traditional telephone. Accordingly, the patient query 119 may be presented to the patient 110 as auditory prompts during a telephone call with the patient 110. The patient query responses 128 may be spoken by the patient 110 or entered by the patient 110 using a touch-tone telephone keypad. The patient device 115 may be a wristband, smart watch, or other wearable device. Such a wearable device may query the patient 110 with self-assessment questions (for example, using a speaker and a microphone) and may also directly measure physical qualities about the patient 110 (for example, temperature, heart rate, motion, and so forth).

According to certain embodiments, the patient device 115 in the form of a wristband, sensor band, smart watch, or other wearable device, may measure significantly more detailed information than traditional vital signs. For example, sampling numerous individual sensors within the patient device 115, such as sensors for pressure, vibration, or motion, may support the patient device 115 operating beyond detecting the pulse in simple beats per minute. Raw data from the numerous sensors may support analyzing details of a pulse waveform containing much more information than simple heart rate. Such a patient device 115 may be operable to detect arrhythmia, mean arterial pressure (MAP), and may provide something like an EKG trace from the patient. Detail enhancement in pulse measurement may support categorizing the waveforms to identify characteristics such as a weak pulse, thready pulse, or other types of cardiology information. Analysis of these sensor signals may include Fourier analysis, Hilbert analysis, correlations, and various other signal processing and signal analysis techniques. Such additional measured or computed data may be used as components in determining the health scores 142.

Even when the patient device 115, such as the wearable technology described above, do not report sufficient information to compute entire health scores 142 on their own, the data that is supplied may be used to compute a portion of a health score 142 or a partial health score 142. Such partial health scores 142 may trigger the health score system 130 to collect or request additional patient data 120 to compute one or more full health scores 142 for assessment. Such a triggering signal may serve as an adaptive mechanism to the patient data collection specification 149. Perturbations in such a triggering signal may indicate that additional patient data 120 would be helpful for further determination of heath score system outputs 140. Adaptive algorithms may also be applied to the sensitivity of the triggering signal.

The collected patient data 120 may include patient query responses 128 provided by the patient 110 in response to patient queries 119. The patient queries 119 issued to the patient 110 can elicit a self-assessment from the patient 110 regarding their health or wellbeing. For example, the patient queries 119 may interview the patient 110 about pain levels, activity levels, medication compliance, sleep quality, sleep duration, food intake, restroom visits, or other questions regarding general wellbeing. The patient queries 119 may also question the patient 110 regarding self measurement of various physiological quantifies such as weight, temperature, blood pressure, blood sugar, pulse oximetry, and so forth. The patient queries 119 may also present the patient 110 with assessment questions seeking to determine state of mind, mental acuity, attention, alertness, other psychological or other emotional qualities of the patient 110. The patient queries 119 may also question the patient 110 regarding their need or desire for addition or reduced care interaction or their satisfaction level with current or recent care experiences.

The collected patient data 120 may include secondary, subjective, or qualitative assessments of patient query responses 128. For example, audio signals provided as patient responses while self-assessment is gathered from a voice telephone system may be examined using voice stress analysis. Similarly, time taken for patients to respond, requests to repeat questions, delays, indications of confusion, or other such subjective patient characteristics may also be part of the collected patient data 120. This information, such as estimated stress or confusion may be considered self-assessment feedback and may used with other collected patient data 120, for example to compute one or more health scores. Voice stress analysis may also be performed from a microphone embedded within a wearable device (such as a smart watch). Voice stress analysis may be performed with respect to active voice signal collection, for example on voice responses to self-assessment queries. Voice stress analysis may be performed with respect to passive voice signal collection, for example on speech or other vocalizations of the patient at any time.

In addition to patient query responses 128, the collected patient data 120 may include outputs from one or more patient sensors 122 or instruments 124. Example instruments 124 may include heart monitors, respiration monitors, oxygenation monitors, blood pressure monitors, and so forth. Similarly, example sensors 122 may include motion sensors, proximity sensors, door switches, light sensors, temperature sensors, and so forth. The sensors 122 or instruments 124 may measure objective medical or lifestyle information about the patient 110. For example, information from the sensors 122 may supplement, or corroborate, patient query responses 128 to determine if the patient 110 is socializing, engaging in physical activities, getting around the house, eating, and/or visiting the restroom as expected. The collected patient data 120 may include vital signs and various related measurements or evaluations of the patient.

The collected patient data 120 may also be in the form of one or more caregiver reports 126. The caregiver reports 126 may be provided by individuals such as home healthcare, nurses, technicians, physicians, caseworkers, friends, family, or neighbors. The various individuals interacting with the patient 110 may place their notes, observations, measurements, and so forth into the caregiver reports 126 associated with the patient 110.

The various examples if patient data 120 may be transmitted to the health score system 130. The health score system 130 may be configured to execute one or more health score system modules 135. The health score system 130 may process the patient data 120 through various rules and algorithms to generate health score system outputs 140.

The health score system 130 can evaluate patient data 120 to determine various metrics and trends in those metrics. One or more health scores 142 may be derived from these metrics and trends within the metrics. The health scores 142 may serve as indicators of the health status of the patient 110. For example, health scores 142 that are generally improving over time after discharge can indicate recovery from a procedure or hospital stay. Alternatively, health scores 142 that are suddenly declining may provide early indications of a complication such as infection or organ failure.

Health score system outputs 140 may be generated by the health score system 130. The health score system outputs 140 may include one or more health scores 142 as well as health score graphs 144 showing the progression of health scores 142 over time or comparing various sets or standards of health scores 142. The health score system outputs 140 may also include medical alerts 146. The alerts 146 may be generated when one or more values form the patient data 120, alone or in combination, cross above or below specified thresholds. Alerts 146 may also be generated when health scores 142 cross above or below specified thresholds. In addition to crossing above or below specified thresholds, alerts 146 may also be generated when certain values (or combinations of values) change too rapidly (e.g. a time derivative exceeds a certain threshold), or fail to change as expected. Alerts 146 may also be generated when the patient 110 fails to respond to patient queries 119 or appears to be doing so in an inappropriate or unexpected fashion.

The health score system outputs 140 may also include various recommendations 148 regarding future health care of the patient 110. The recommendations 148 may include a suggested course of action for the patient 110 including suggested tests or procedures to be considered. The recommendations 148 may also include suggestions to the patient 110 to another type, or category, of healthcare facility (for example, from a nursing home to hospice). The recommendations 148 may also include evidentiary support for maintaining a certain level or type of care for a patient. The recommendations 148 may also include suggested changes in types of medications, dosages of medications, dietary intake, physical activity levels, and so forth.

The health score system outputs 140 may also include the patient data collection specification 149. The patient data collection specification 149 can indicate the nature and frequency of patient queries 119. The health score system 130 can generate or update the patient data collection specification 149 to adapt to a need for additional data points, or different type of data, from the patient 110. For example, a patient 110 who the health score system 130 has determined to potentially be in the early stage of a physiological decline may receive more frequent telephone calls, or computerized messages, to issue patient queries 119 regarding the condition of the patient 110. The patient data collection specification 149 may indicate the frequency of collecting various examples of patient data 120 including those from patient sensors 122, instruments 124, and caregiver reports 126.

In general, the patient data collection specification 149 can include specifications to commence, terminate, or modify patient data collection, which may also include information queries or instructions issued to the patient 110. The patient data collection specification 149 may be derived from one or more adaptive intelligence algorithms in association with patient data 120. In addition to being generated by the health score system 130, the patient data collection specification 149 may be complimented by feedback from one or more human recipients 150 of the health score system outputs 140. The recipients 150 may be caregivers 152, caseworkers 154, family 156, or friends/neighbors 158. The caregivers 152 may be anyone practicing healthcare in a professional or non-professional capacity, such as physicians, nurses, technicians, family members and so forth.

The monitoring of health score system outputs 140 by the recipients 150 can significantly improve patient outcomes. The catastrophic deterioration of a patient's overall health is frequently preceded by documented deterioration of physiological parameters. Traditional rapid response teams in healthcare may be triggered by one parameter at a time, and that parameter often represents a significant change in a particular vital sign. For example, a significant change in blood pressure, or a significant change in skin color might trigger a call. In some cases, a general feeling that something is not right might lead to a call. Failure of clinical staff to respond to deterioration of respiratory or cerebral function and increase levels of medical intervention may often put patients at risk of cardio-respiratory arrest. In general, inappropriate action in response to observable abnormal physiological and biochemical variables might lead to avoidable death. The complimentary self-assessment health scoring system 100 can significantly improve patient outcomes with regard to mortality, readmissions, and general patient satisfaction and wellbeing. These improvements may often be realized while also reducing costs.

During the course of care for a patient 110, they may see many caregivers 152 such as technicians and nurses. Variations in these caregivers 152 can make it extremely difficult to provide continuity of care. The patient 100 may have tens or hundreds of pages in their record, including progress reports, nursing evaluations, records of vital signs, test results, heart monitoring information, and so on. Even if every caregiver 152 who saw the patient were fully aware of the material in this record, it may not be enough to allow for the best medical care because it is very difficult to detect trends in such voluminous data. The result of this arrangement has been to allow a number of patients in recovery, post-operation or procedure, to deteriorate to the point of medical crisis before addressing their problems. This causes a serious drain to the resources of the hospital, and unnecessary pain and suffering, even death. It is particularly bothersome because many of the conditions that lead to such crises can easily be avoided if the failing condition of a patient were detected hours or days earlier.

It should be appreciated that certain types of patient data 120 may become available to the health score system 130 at different times or sampling rates. For example, a heart rate signal from a wearable patient device 115 may be almost continuously updated, while a caregiver report 126 may only be available once each day, and laboratory data may only be updated every several days. More frequently available patient data 120 may be used to compute a portion of a health score 142 or a partial health score 142. Such partial health scores 142 may trigger the health score system 130 to collect or request additional patient data 120 to compute one or more full health scores 142 for assessment. Such triggering signals from partial health scores 142 may serve as an adaptive mechanism with respect to the patient data collection specification 149.

Similarly, caregiver reports 126 may have different timeframes. For example, within a skilled nursing facility, technicians or nursing assistants (such as CNAs) may spend more time with a patient than a nurse (such as an RN). Variations or concerns registered in the patient data 120 supplied by a CNA may trigger a visit from an RN along with an associated caregiver report 126.

Aspects of the health score system outputs 140 presented herein relate to the development of a general measure of risk for the patient 110, sensitive to a range of patient conditions, available for use by various recipients 150 to assess a patient's state, and more particularly to recognize downtrends which may indicate the onset of a complication.

Various tests, such as blood or urine tests, may be conducted to evaluate a patient and collect patient data 120. Similarly, the patient 110 may be evaluated or measured by various sensors 122 or instruments 124 that collect raw medical data. Through various patient queries 119, the patient 110 may be asked about eating habits, mood, vaccinations, drugs taken, problems with walking, the amount of help needed with daily activities, and living arrangements. The patient 110 may be asked a standard series of questions to evaluate mental function. As recorded in caregiver reports 126, various physical assessments may be performed on the patient 110 to gather information about physiological, psychological, sociological, and spiritual status. A comprehensive patient assessment yields both subjective and objective findings. Subjective findings may be obtained from the health history and body systems review. Objective findings may be collected from the physical examination. Subjective data may be apparent only to the patient affected and can be described or verified only by that patient 110. Pain, itching, and worrying are examples of subjective data. Both subjective and objective information may be captured within the patient data 120.

Although objective data, such as blood pressure, heart rate, vital signs, or other numerically measurable factors may be used to generate one or more numbers representing overall patient health, subjective data, may be very significant in predicting the general health of the patient 110. Subjective data may be acquired through self-assessments using patient queries 119 and may include warmth of skin, moisture of skin, symptoms of hypotension, chewing, swallowing, manual dexterity, feeling/appearance of abdomen, bowel sounds, nausea, vomiting, continence, urinary voids, urine color, urine odor, ability to move extremities independently, use of assistive devices, alertness, recognizing persons, orientation to place, orientation to time, speech coherence, pain levels, peripheral vascular warmth, capillary refill, peripheral pulses, edema, numbness, tingling, breath sounds, nail beds, mucous membranes, sputum, cooperation, and so forth. Such factors may be determined through patient queries 119 using a pass/fail, numerical, or letter grade score. Even when the factors may be scored on a pass/fail basis, the transition from passing to failing may be very predictive in indicating the health of the patient 110. For example, if a patient 110 moves from failing two measures, to failing five measures, and then to failing seven measures, the patient 110 may be going through a very serious decline in health, even if vital signs are relatively normal or not changing.

According to certain embodiments, the patient data 120 may incorporate medical data available from an electronic medical record (EMR) system. An EMR may be a computerized legal medical record created within a health organization that delivers care.

The complimentary self-assessment health scoring system 100 may support efficiency in resource allocation. For example, a caregiver may be allocated where most needed using scores and evaluations associated with the technology presented herein. Improving allocation of resources, such as nurses seeing patients, can increase caregiver efficiency. Responding sooner to those patients who are most at risk can increase the effectiveness of the caregivers.

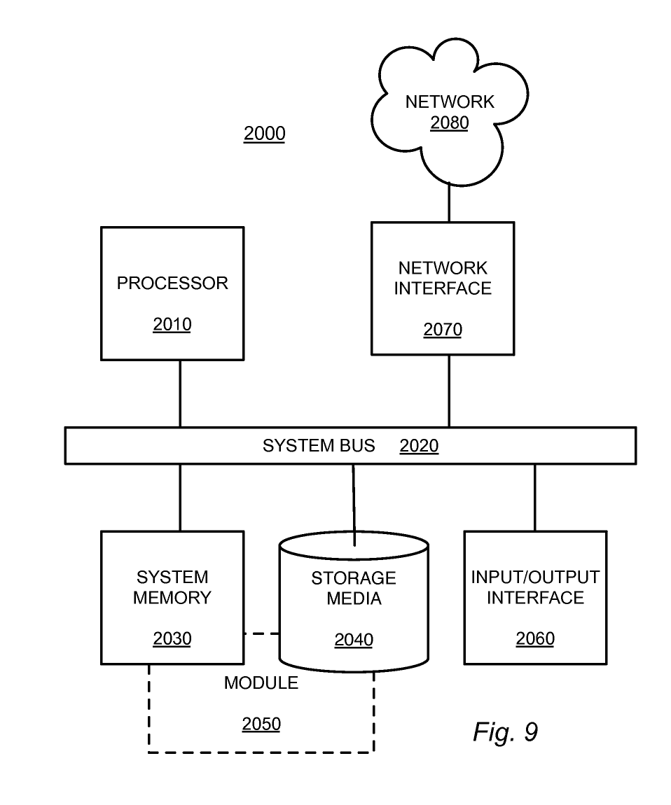

Within the complimentary self-assessment health scoring system 100, the patient device 115, the health score system 130, systems associated with patient data 120, systems associated with the recipients 130, or any other systems associated with the technology presented herein may be any type of computing machine such as, but not limited to, those discussed in more detail with respect to FIG. 9. Furthermore, any modules (such as the patient device modules 117 or the health score system modules 135) associated with any of these computing machines or any other modules (scripts, web content, software, firmware, or hardware) associated with the technology presented herein may be any of the modules discussed in more detail with respect to FIG. 9. The computing machines discussed herein may communicate with one another as well as other computing machines or communication systems over one or more networks such as network 160. The network 160 may include any type of data or communications network including any of the network technology discussed with respect to FIG. 9.

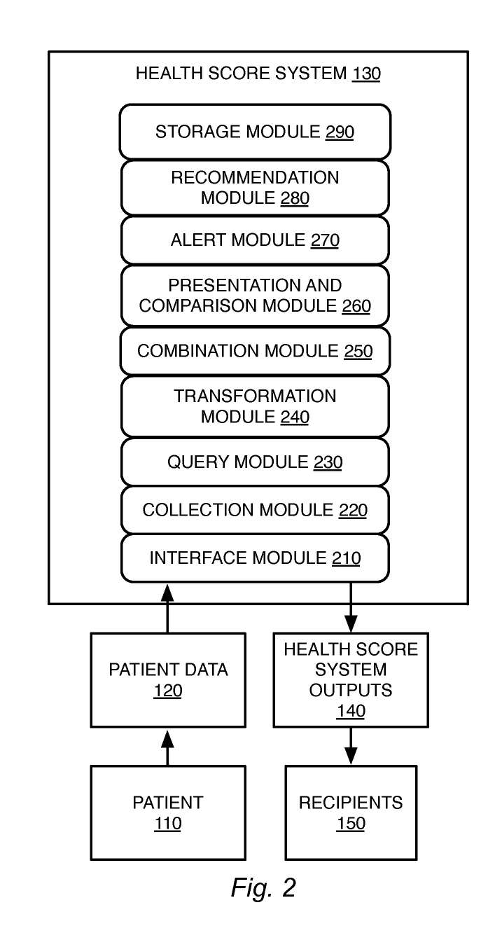

FIG. 2 is a block diagram illustrating a health score system 130, in accordance with certain exemplary embodiments. The health score system 130 may include various health score system modules 135 for generating, interpreting, and presenting one or more health scores 142 and various other health score system outputs 140. The health score system modules 135 may include an interface module 210, a collection module 220, a query module 230, a transformation module 240, a combination module 250, a presentation and comparison module 260, an alert module 270, a recommendation module 280, and a storage module 290.

The interface module 210 may receive patient data 120. The interface module 210 may be configured to obtain or receive the patient data 120 directly from the patient 110 or from other sources as presented herein. The interface module 210 may generate health score outputs 140 to be provided to one or more recipients 150.

The collection module 220 can aggregate the patient data 120 from the interface module 210. The aggregated data may be provided to the storage module 290. According to certain embodiments, the patient data 120 may be provided to the transformation module 240. The patient data 120 may also be provided to the presentation and comparison module 260.

The query module 230 may determine the contents and frequency of the patient queries 119. The patient queries 119 may be selected from a database or list of standard queries. Various operational rules may be applied to determine which patient queries 119 should be supplied to the patient 110 and at what times and frequencies.

The transformation module 240 can receive incoming patient data 120 and convert (transform) the data into a usable format for generating one or more health scores 142 associated with the patient. The transformation module 240 can convert each type of patient data 120 into a form that will allow different types of data to be combined. For example, all patient data 120 may be transformed into a scaled value. The transformation module 240 can convert raw patient data 120 into scaled numbers based on various derived transformation functions as presented herein. In one or more embodiments, these transformation functions may be stored within the health score system 130. In one or more embodiments, the transformation functions may be stored in the memory of a separate computer or computing device that is in communication with the health score system 130. In one or more embodiments, the transformation module 240 may convert each type of patient data 120 by operating upon the patient data 120 using one or more excess risk functions that, such as those presented herein. In one or more embodiments, the transformation module 240 may take a past value of one type of patient data 120, compare it with a current value of the same type of patient data 120, determine the change in the patient data value 120, and use the change in value as the input to an excess risk function. In one or more embodiments, the transformation module 240 may take past values of one type of patient data 120, add it to a current value of the same type of patient data 120, determine an average value for the patient data 120, and use the average value as the input to an excess risk function.

As an illustrative example, if a sample of raw patient data 120 collected from the patient 110 is a hemoglobin (Hgb) value corresponding to 10.47 gm/dL, the health score value can be determined by plugging the value of 10.47 gm/dL into a sixth order polynomial function, which represents excess risk due to deviation from normative values, as a function of hemoglobin measured against one-year mortality. This would result in a health score value for hemoglobin of approximately ten percent. Therefore, the transformation module 240 would convert the Hgb value of 10.47 gm/dL to a transformed health score value of ten percent. Similarly, if a sample of patient data 120 collected from the patient 110 is a creatinine value corresponding to 2.5 mg/dL, the health score value can be determined by plugging the value of 2.5 mg/dL into the sixth order polynomial function, which represents excess risk due to deviation from normative values, as a function of creatinine measured against one-year mortality. This would result in a health score value of approximately 31 percent. Therefore, the transformation module 240 would convert the creatinine value of 2.5 mg/dL to a transformed health score value of 31 percent.

The transformed data may then be provided to the combination module 250, which in turn may generate the health score 142, using a predetermined algorithm. In one or more embodiments, the combination module 250 may take the sum of each of the single-variable risks given by the transformed health scores. The combination module 250 may combine the transformed health score values and scale them, so that they span a given range. According to certain embodiments, when a health score were defined so that a high value corresponded to “good health” and a low value corresponded to “poor health,” then the scaled total transformed health score 142 would be subtracted from the “best” value of health. For example, if the best value were 100, and the range was to be 100, that is poor health was to correspond to zero, then the scaled total transformed health score value would be subtracted from 100. If the scale factor was 0.1 and a health score was computed based just upon these two variables, the two health score variables could be combined (10+31=41) and then the quantity 41 times 0.1 (or 4.1) would be subtracted from 100 and come up with a health score of 95.9. Therefore, the combination module 250 would generate a health score for the patient to be 95.9 at that time. This example describes a health score 142 determination on two types of patient data 120. Typically, the health score 142 would be determined based on and larger number of types of patient data 120. This larger number may be 10, 15, 20, 25, 30 or more types of patient data 120.

The presentation and comparison module 260 may receive the calculated health score 142 and may prepare a health score graph 144, plotting the health scores 142 for a patient 110 as a function of time. In some embodiments, the presentation and comparison module 260 may render, for display upon a screen or monitor, the health score 142 as a health score graph 144 over a predetermined time frame. The rendered health score graph 144 may be presented to on or more recipients 150 or the patient 110 for visualizing health trends in the patient 110.

The alert module 270 may generate alerts 146. An alert 146 may be activated when the health score 142 descends below an acceptable threshold or if a downward trend is detected. The storage module 290 may be configured to store and retrieve health score information at various times during the health score generation and presentation processes. The recommendation module 280 may generate recommendations 148 suggesting one or more courses of action associated with patient care. It should be appreciated that an alert 146 may comprise a sampling or history of health scores 142, any combination of health score outputs 140, or any notifications or communications associated therewith.

It should be understood that the illustrated health score system modules 135 are merely one example of the logical organization of modules within the health score system 130. For example, many of the modules may be combined with one another or subdivided and separated according to their function. It should be appreciated that any other modular organization within another health score system 130, employing variously differing logical modules to obtain, interpret, and/or present a health score 142 does not depart from the spirit or scope of the technology presented herein.

Furthermore, it is noted that the modules of the health score system 130 are illustrated to show their logical relationship to one another according to certain embodiments. However, this is not intended to limit the physical construction of such a system. For example, the health score system 130 may be employed on a single larger computer or on a series of smaller computers, possibly with different components residing within different geographical locations, such as the use of an off-site storage module 290. Any other embodiment of such a health score system 130 may employ similar modules to generate a health score alert, as not all embodiments of the present disclosure are intended to be limited in this manner.

### Example Graphs and Data Structures

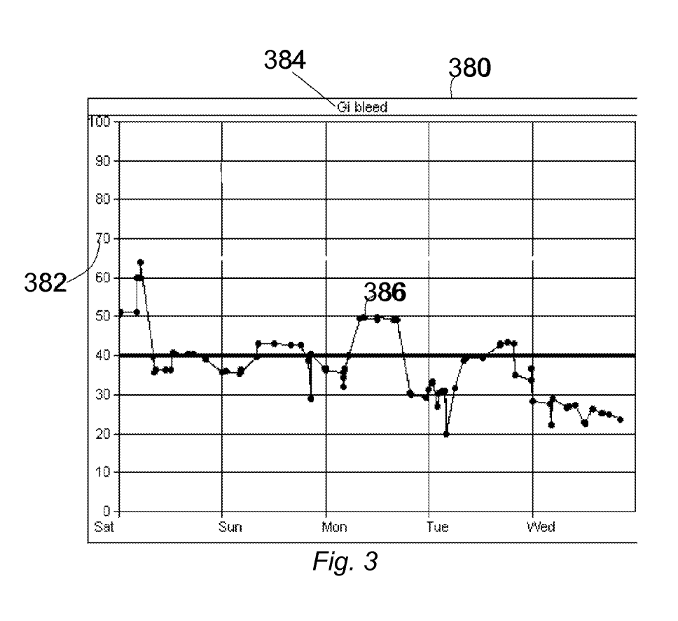

FIG. 3 is a chart 380 showing a health score graph 144, in accordance with certain exemplary embodiments presented herein. The illustrated health score graph 144 plots a series of health scores 142, calculated by the health score system 130, as a function of time. The chart 380 includes scale markings 382, a heading label 384, and a plot 386. The plot 386 is one example health score graph 144 for a patient recovering from a gastrointestinal (GI) bleed. During a GI bleed, the amount of bleeding can range from nearly undetectable to acute, massive, and life threatening. At the beginning of plot 386 (which is the first of the five days represented), the patient had a health score 142 in the low 50s. Shortly thereafter, the patient's health score 142 improved to a value in the 60s. However, at some point on the first day, the health score 142 began to decline quickly from a value in the 60s to a value in the 30s. Accordingly, at the middle of the first day, the health score graph 144 can prove to be a critical tool for medical care. The illustrated health score graph 144 may make it very clear to a recipient 150 that something is going wrong with the patient 110 at the end of day one. This may be a critical time for the patient 110 where immediate treatment may prevent a crisis.

As described herein, health scores 142 for a patient 110 may be generated by computing excess risk due to deviation from normative values, as a function of each type of medical data measured against one-year mortality. To provide the health score with continuous input functions for each type of medical data, average one-year mortality versus averages of each type of medical data for distinct ranges, may be fit to higher-order polynomials based on data obtained from an EMR for a plurality of different patients.

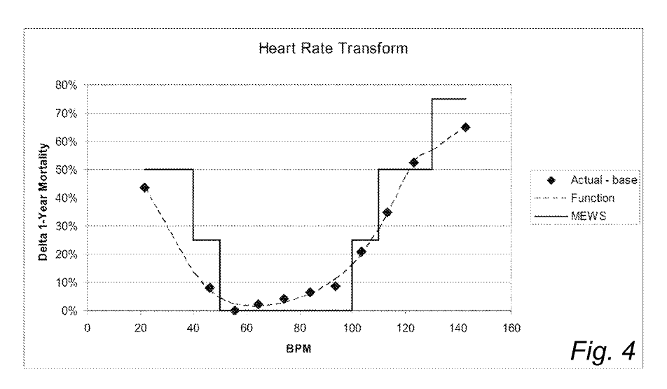

FIG. 4 is a graph of an excess risk curve where an outcome measurement is a function of heart rate at discharge, in accordance with certain exemplary embodiments. The outcome measurement is a likelihood of mortality one year after discharge. The medical data was obtained from EMR data from about 22,000 patients. A polynomial (such as a sixth order polynomial) may be constructed to define the excess risk due to deviation from normative values. The excess risk curve shows that a heart rate value of approximately 55 BPM (conventionally considered in the range of “well-trained athletes”) results in a zero percent excess risk for a patient, however a heart rate value of approximately 92 BPM (conventionally considered in the high range of a “normal value”) results in an about nine percent excess risk for a patient. Also illustrated is a Modified Early Warning System (MEWS) curve for heart rate, which identifies people at risk of deterioration in a busy hospital ward. The MEWS curve contains a risk transform in the form of a step function: output=2 if HR<40, output=1 if HR is between 40 and 50, output=0 if HR is between 51 and 100, output=1 if HR is between 100 and 110, output=2 if HR is between 110 and 130, and output=3 if HR is greater then 130. The step function is plotted by setting 1 point=25%. As illustrated graphically, there is a correspondence between the two transformation curves (MEWS) and the excess risk curve of the function even though these may be derived completely independently. The MEWS step-function curve comes from the accumulated observations of experts in the field. In this case doctors having witnessed many patients go through crises.

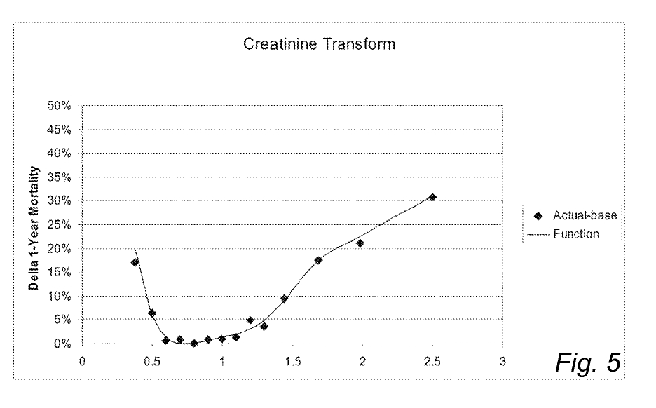

FIG. 5 is a graph of an excess risk curve where an outcome measurement is a function of creatinine at discharge, in accordance with certain exemplary embodiments. The outcome measurement is a likelihood of mortality one year after discharge. The medical data was obtained from EMR data from about 22,000 patients. A sixth order polynomial (fit in the range of 0.37 mg/dL to 2.5 mg/dL) defining the excess risk due to deviation from normative values for bicarbonate was derived. The excess risk curve shows that a creatinine value of approximately 0.8 mg/dL conventionally considered a “normal value”) results in a 0% excess risk for a patient, a creatinine value of approximately 2.5 mg/dL (conventionally considered a “high value”) results in an about 31% excess risk for a patient, and a creatinine value of approximately 0.37 mg/dL (conventionally considered a “low value”) results in an about 17% excess risk for a patient. If a creatinine value for a different patient is less then 0.37 mg/dL, then delta-one year mortality will be equal to 20%. If a creatinine value for a different patient is more then 2.5 mg/dL, then delta-one year mortality will be equal to 30%.

In yet another example of an excess risk curve (not illustrated here), an outcome measurement (mortality 1-year post discharge-base) is a function of a continuous variable (bicarbonate) at discharge. The medical data was obtained from EMR data from about 22,000 patients. A 6th order polynomial defining the excess risk due to deviation from normative values for bicarbonate was derived. The excess risk curve shows that a bicarbonate value of approximately 24 mEq/L (conventionally considered a “normal value”) results in a 0% excess risk for a patient, however a bicarbonate value of approximately 13 mEq/L (conventionally considered a “low value”) results in an about 33% excess risk for a patient.

In yet another example of an excess risk curve (not illustrated here), an outcome measurement (mortality 1-year post discharge-base) is a function of a continuous variable (hemoglobin) at discharge. The medical data was obtained from EMR data from about 22,000 patients. A 6th order polynomial defining the excess risk due to deviation from normative values for bicarbonate was derived. The excess risk curve shows that a hemoglobin value of approximately 15.5 gm/dL (conventionally considered a “normal value”) results in a 0% excess risk for a patient, however a hemoglobin value of approximately 7.64 gm/dL (conventionally considered a “low value”) results in an about 13.1% excess risk for a patient.

In yet another example of an excess risk curve (not illustrated here), an outcome measurement (mortality 1-year post discharge-base) is a function of an ordinal score (Braden Scale) at discharge. Medical data used to derive the function was obtained from EMR data from about 22,000 patients. Points on the graph are average one-year mortality for a given Braden scale score less base mortality for a Braden score of 23 (base mortality is 2.6% for a Braden score of 23). Average one-year mortality versus average Braden scale score for distinct ranges were fit to a 5th order polynomial.

In certain embodiments, the type of medical data that is collected is a categorical class. An example of a categorical class includes, but is not limited to, a heart rhythm distinction. In an embodiment, the heart rhythm distinction includes sinus bradycardia, sinus rhythm, heart block, paced, atrial fibrillation, atrial flutter, sinus tachycardia and junctional rhythm. In an embodiment, the type of medical data that is collected is a binary assessment. An example of a binary assessment is subjective data, such as nursing assessments. In an embodiment, the binary assessment is a nursing assessment. In an embodiment, the variable selected from the nursing assessment includes, but is not limited to, a food assessment, a neurological assessment, a psychiatric assessment, a safety assessment, a skin assessment, a genitourinary assessment, a muscular-skeletal assessment, a respiratory assessment, a cardiac assessment, a peripheral vascular assessment, a gastrointestinal assessment, a Braden scale assessment and a pain assessment.

In yet another example of an excess risk curve (not illustrated here), an outcome measurement (mortality 1-year post discharge-base) is a function of a categorical class (heart rhythm distinction) at discharge. The medical data was obtained from EMR data from about 22,000 patients. The excess risk curve shows that a heart rhythm of sinus bradycardia (conventionally defined as a heart rate of under 60 BPM) results in a 0% excess risk for a patient. A heart rhythm of atrial fibrillation (conventionally defined by the quivering of the heart muscles of the atria) results in a 21% excess risk for a patient. A heart rhythm of junctional rhythm results in a 29% excess risk for a patient.

In yet another example of an excess risk curve (not illustrated here), an outcome measurement (mortality 1-year post discharge-base) is a function of a binary assessment (food/nutrition nursing assessment) at discharge. Medical data used to derive the function was obtained from EMR data from about 22,000 patients. The excess risk curve shows that if a patient has failed a food/nutrition nursing assessment, there is a 43% excess risk for a patient.

It should be understood that although the embodiments described with resect to these examples of excess risk curves, functions are derived based on a single independent variable (type of medical data), the methods disclosed herein are also applicable for deriving functions based on two or more independent variables (types of medical data). As with functions of one variable, functions of several variables can be represented numerically (using a table of values), algebraically (using a formula), and sometimes graphically (using a graph).

According to various embodiments, a general measure of risk for a patient, sensitive to the full range of patient conditions, independent of diagnosis, is developed which can be used to assess a patient's state, and more particularly to system and methods for recognizing downtrends which may indicate the onset of a complication. Certain embodiments of the present inventions provide systems and methods for recognizing downtrends in a patient's health, which may indicate the onset of a complication, and to aid in communication of this information across staff handoffs. At least some of the embodiments allow for continually tracking the health of a patient in their location (home, nursing home, hospice, hospital, rehabilitation center, and so forth). At least some of the embodiments allow various caregivers to provide more effective health care for each patient. In addition or alternatively, at least some embodiments assist caregivers in avoiding errors and reducing crisis management by using the systems' capability to detect trends in a patient's health before the patient reaches a crisis point. Recognizing a decline soon enough to administer proper treatment may be a life-saving benefit. Embodiments of the system may give caregivers a way in which to get the “big picture” of a patient's condition and absorb in a glance perhaps 100 pages of a patient's medical records. This deeper understanding, along with this new capability to detect health trends, short-term (over the space of hours) and/or long-term (over the space of days) may be important in delivery of effective medical care. Embodiments may enable a new field of scientific study, where medical and surgical treatments can be evaluated by the new measurements provided by embodiments of the present disclosure.

Various embodiments of the present disclosure may generate a patient health score 142. The health score 142 may be continually plotted and displayed to show each patient's medical progress during his hospital stay. The health of the patient may relate a patient's vitality and overall quality of life rather than simply being free from disease. Although a patient who has a terminal disease, such as cancer, may conventionally be considered to be in poor health; however, if a cancer patient who only has a few months to live is playing a game of ping-pong for hours, he/she may be considered to be in good health, as the term is used herein. In comparison, a patient who entered the hospital to have a simple surgery, such as a tonsillectomy, may conventionally have been considered to be and will likely recover to be in excellent health. However, while recovering, the tonsillectomy patient's vitality might be low and his/her chance of dying in the near future could be much higher if a complication were to arise; thus, the patient may be considered to be in poor health, as the term is used herein. The health of a patient may relate to the patient's overall physical, mental, spiritual and social wellbeing and not merely the absence of disease or infirmity. Embodiments of the present invention may significantly improve the quality and continuity of medical care.

In addition to the features of the health score and uses thereof, it is further contemplated that an exemplary use of such system may include the use of the health score to provide a panel of health score charts, providing caregivers an overview as to the progress of many patients at one time, as is described further below.

In one embodiment, the health score may be used to predict the odds of a crisis within N number of hours. That is, for example, there is a 20% chance of a crisis in the next 12 hours. This information may be used to assign additional observation to particular patients, or if a crisis is judged to be imminent, a call may be initiated to a Rapid Response Team. Another use for the health score is to schedule caregiver visits. This will allow the caregiver to quickly move to patients requiring more attention first, and then proceed to less critical patients.

One way in which a crisis may be predicted is by comparing the individual patient's health score with a standard recovery or wellness curve. By tailoring the standard recovery curve to the patient, better results may be obtained. For example, one of the exemplary ways in which patients may be categorized is by DRG/ICD-9 grouping systems. DRG stands for a diagnostic related group and ICD-9 is the international classification of disease. Both of these are ways of categorizing patients based on what disease or ailment the patients have and are employed by insurance companies to figure out how much the insurance company should pay out for a particular policyholder. For example, the standard recovery curve for someone having had elective rhinoplasty is likely to be very different from the standard recovery curve of someone who had a heart-lung transplant. If the rhinoplasty patient's health was declining, but the rhinoplasty patient's health was viewed in comparison with someone who had serious surgery, such as a heart-lung transplant, the decline might not be viewed as being significant, while in reality the rhinoplasty patient could be about to experience a cardiac or respiratory crisis. If the transplant patient's health is improving, but the patient's health is viewed in comparison with other patients who have had the same procedure and the recovery is much slower this could be an early indication of a complication. By comparing patients based on their disease, treatment/surgery, or affliction, the patient's health score may be better interpreted.

In some embodiments, ICD-9, which groups patients into thousands of detailed categories, normative data plots may be used, while in some embodiments DRG, which groups patients into about 500 categories, may be used, while in yet other embodiments, a combination of the two grouping systems may be used. Not all embodiments are intended to be limited in this respect and any disease grouping system or data may be employed to create a singular or combination standard recovery curve.

According to various embodiments, creating the standard curve may entail reviewing graphs of all previous patients with the same DRG/IDC-9 code in a database and plotting them as one or more curves. The curve may be represented by an average curve, all of the individual patient's curves, a median curve, a top 25th percentile and a bottom 25th percentile, plus or minus some number of standard deviations thereby creating a normative recovery as well as upper and lower bounds, any combination of the foregoing or any other representative indicator as not all embodiments of the present disclosure are intended to be limited in this respect. By using these types of normative curves a doctor may be able to see that even if a patient is recovering, the patient might be recovering more slowly (too shallow a slope) than the average patient with a similar condition and this slower recovery might be cause for further investigation.

Not only may the grouping codes be useful in comparison with the health score, but the grouping codes may be utilized in generating a more accurate health score. In some embodiments, a user may modify the algorithm used to generate the health score based on the diagnosis or grouping code of the patient in order to have the health score more accurately reflect the patient's recovery

In some embodiments, the life expectancy or mortality of a patient, such as the likelihood that a patient will die within the next 24 hours, may be predicted. For example, if a terminal patient is listed as DNR (do not resuscitate) or “keep patient comfortable,” a family member may want to know the life expectancy of the terminal patient to plan for the inevitable death.

By comparing a patient's health score with a standard, many inferences may be drawn from the comparison. For example, in some embodiments, patients may be given a category, such as critical, critical but stable, serious, serious but stable, fair, and/or good. These categories may be words or terms, numbers (such as 1-5 or 1-100), colors (such as red, orange, yellow, or green), a made up system of categorizing, or any other system. In addition, the categories may be discrete, such as choosing one of four colors or may be continuous, such as choosing any number from one to 100.

By having patients categorized, administrative decisions and care priority can be determined accordingly. For example, in some embodiments, a nurse scheduling tool may be incorporated or separately determined which would allow shift nurses to see the conditions of all patients on the floor and assign nurses based on skill level, so that more experienced nurses have more critical patients and newer nurses have more stable patients. In some embodiments, the nurse scheduling tool may rank patients, for example, 1-10 and allocate patients to each nurse so that no nurse has a total patient rank of for example, more than 25 (e.g., two very critical patients of rank 10 and one fair but stable patient of rank 5, four fair but stable patients of ranks 5.2, 5.4, 5.7 and 6.1, or two serious patients of rank 8 and one serious but stable patient of rank 7.2). In some embodiments, the ELOS prediction may be incorporated into the nursing schedules, so that discharges may be predicted and the charge nurse may be able to know how many staff members may be required to work an upcoming shift. Similarly, these systems may be applied to routing a doctor's rounds, as described above.

In another possible arrangement, the health score may be used to determine priority and timing of the post-discharge “how are you doing” call. For example, patients leaving the hospital with favorable heath scores may be called in three days for a checkup, whereas patients with marginally acceptable heath scores may be called sooner.

The heath score as disclosed in the incorporated documents, and above may be fine-tuned to each hospital in which it is implemented. Most hospitals have slight differences in procedures, standards, requirements and other elements of daily practice as compared to other hospitals and some embodiments of the present disclosure may be adapted to a specific hospital's preferences. In particular, when using subjective variables to produce a health score, as will be described further below, some hospitals may be more conservative in evaluating a patient's condition. For example, nurses at a first hospital may be taught that slightly grey skin is a reason to fail a skin assessment while nurses at a second hospital may be taught that a patient should pass a skin assessment until the skin is really grey. This difference may make average scores on the health score lower at the first hospital, which could mean that the predicted health of a patient would appear worse at the first hospital than at the second hospital. By adjusting the health score according to an individual hospital's procedures, the health score may be more accurate.

In some embodiments, the heath score may be used for evaluation purposes. For example, the health score may be used to evaluate the performance of a particular caregiver, or even of a care facility. It can also be used to evaluate a particular treatment by studying heath score charts of patients that underwent a particular treatment.

In addition to evaluation of caregivers, the system may be used to compare effectiveness of medical treatments, compare the quality of care provided by different wards or facilities, and compare the skill of healthcare providers by providing an objective assessment of a patient's health and response to various factors. In some embodiments, the algorithm may be customized after a patient's stay to further evaluate the care of the patient and compare the patient with other patients. For example, if two patients had the same diagnosis and received different treatments, a facility or caregiver may want to compare those two patients' recoveries. However, if one patient had a small drop in their health score due to an unrelated event, such as having an allergic reaction to topically applied medication, the algorithm may be adjusted to exclude a factor, such as a skin standard of the nursing assessment, from the health score of both patients, so that the two patients are still evaluated using the same algorithm, but the comparison is tailored to focus on the recovery from the treatments and exclude unrelated deviations.

In another embodiment, the health score chart shapes can be clustered to discover the “types” of patient health trajectories. General prototypical trajectories, or trajectories computed as a function of disease or procedure may be compared against actual health score charts to determine how a particular patient is responding to treatment. Once a health score chart is assigned to such a prototypical trajectory, it may further indicate the likelihood of various outcomes. In some embodiments, this may be accomplished by using DRG/IRC-9 groupings, as discussed herein.

In another embodiment of the present disclosure, the health score may be used as part of a remote monitoring service, where a remote health service provider can monitor the score of several patients and alert an on-site staff if there is an emergency. The health score can be refined using neural networks, or other analytical methods. The health score may be fed to a central data hub and be used to monitor for large-scale trends in health problems, including a biological or chemical attack.

While in some embodiments an individual health score falling below a minimum mark or the change in health score or slope of the health scores falling below a minimum change may trigger an alarm or be interpreted by a healthcare provider as an indication of the patient's declining health, in some embodiments the change in slope or derivative of the slope of the health scores falling below a certain minimum may trigger an alarm or be interpreted by a healthcare provider as an indication of the patient's rapidly declining health. For example, if a patient is slightly declining and suddenly starts to decline at a much faster rate, this change in the acceleration of the slope may trigger an alarm. In some embodiments, the curvature of the health score plot may be provided, such as by a presentation and/or comparison module.

Many times a patient's health may be compromised in favor of conforming the patient's care to hospital standards. For example, taking a patient's vital signs every two-to-four hours generally requires awakening patients during the night and often times not allowing them to complete a full sleep and enter deep sleep, which may be critical to a patient's recovery, and to draw blood from patients every day or two, which can be detrimental to an anemic or hemophiliac. If a patient has been recovering well and has an increasing health score, a healthcare worker may rely on the health score to determine whether or not a routine test or procedure may be skipped in order to allow the patient to better recover.

The system may include the ability to view a patient's prior visits to hospitals or other relevant facilities. In some embodiments, if a patient has a recurring condition, it may be preferable to view that patient's past health scores in addition to the present health score. In addition or alternatively, the graph may display a one or more health scores calculated using different inputs, such as a red line with circular data points for when the entry reflects nursing assessments, a blue line with square data points for blood work and/or a green line with triangular points for a chem panel. Differences in data source may be represented with unique icons or any other means of differentiating them, as not all embodiments are intended to be limited in these respects. In addition or alternatively, a caregiver may click on or hover over a point to access additional information, such as the data inputted to calculate the health score, an average reading, values from earlier in the patient's stay, or any other information.

In some embodiments of the present disclosure, a health score system is provided for generating and presenting a health score chart. The health score may be a medical reference “figure-of-merit” that is used by a health caretaker, such as a physician, nurse, or other health attendant, to track the patient's health before, during or after a medical procedure or illness, in order to assist in preventing that patient from reaching a health crisis. When used in this manner, the health score chart enables the attending physicians and nurses to detect trends in the patient's health over time. The health score chart also provides a statistically significant “outcome” for both clinical studies and retrospective studies of the relative efficacies among various surgical procedures or techniques, and among medical treatments and drugs.

In addition to short-term intensive use of the health score system, a similar modified form may be used on a long-term basis by regular general practitioners or other health care facilitates such as nursing homes. For example, as it stands, yearly physicals are usually accompanied by a series of medical measurements of the patient. Entering such data in health score system may be useful in spotting long term declining health trends, even if none of the particular medical conditions have reached a crisis level.

### Example Processes

According to methods and blocks described in the embodiments presented herein, and, in alternative embodiments, certain blocks can be performed in a different order, in parallel with one another, omitted entirely, and/or combined between different example methods, and/or certain additional blocks can be performed, without departing from the scope and spirit of the invention. Accordingly, such alternative embodiments are included in the invention described herein.

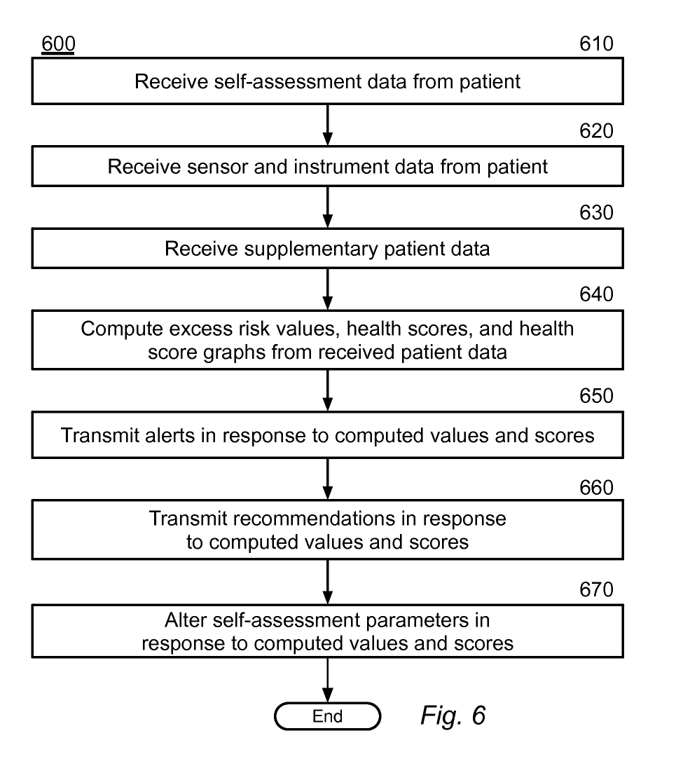

FIG. 6 is a block flow diagram depicting a method 600 for adaptive complimentary self-assessment for patient health scoring, in accordance with certain exemplary embodiments. In block 610, self-assessment data may be received from the patient 110. The self-assessment data may include patient query responses 128 to health and wellness related patient queries 119. The patient queries 119 may seek to ascertain how the patient feels subjectively, how energetic or vital the patient is, the patients quality of life, how the patient is eating and sleeping, how the patient is complying with medications and/or therapies, how the patient rates their perception of pain or discomfort, and so forth. These patient queries 119 may be administered by voice telephone call, instant messaging, text messaging (SMS), television set top box, networked appliance, voice conference, video conference, in person, via web site, software application, mobile (smartphone/tablet) application, wearable computing device (smart watch), smart appliance, or through any other communication device or computing machine.

In block 620, data may be received from sensors 122 and/or instruments 124 associated with the patient 110. Sensor data may include indoor motion sensors, door/window switches, patient-motion sensors (e.g. fitness monitor watch or wristband), accelerometer, pedometer, and so forth. Such sensors 122 can detect how much a patient is moving around their house or room, how frequently they go to the kitchen (as a proxy for how well they are eating), how frequently they visit the restroom, how often they leave the house, how many steps they take each day, how restfully and how long they sleep, and so forth. Instruments 124 may include heart monitors, blood oxygen monitors, respiration monitors, blood/urine test machines, oxygen tanks or concentrators, insulin pumps, temperature sensors, weight scales, blood pressure cuffs, pain medication pumps, or any other medical or physiological monitors or instruments.

In block 630, supplementary patient data may be received. The supplementary patient data may include caregiver reports 126 incorporating information reported from various caregivers o other recipients 150. The supplementary patient data may also include lab results and medical data such as that from one or more EMR systems.

In block 640, excess risk values, health scores 142, and health score graphs 144 may be computed from received patient data 120. The various pieces of patient data 120 received in blocks 610, 620, and 630 may be scaled and/or combined and optionally combined with supplementary patient data (such as chart data, medical records data, and previous computed values) to compute various excess risk values, composite excess risk values, combined health scores, and graphs/plots of health score trends over time.

In block 650, alerts 146 may be transmitted to one or more recipients 150 in response to the computed values or scores from block 640 crossing a specified (or computed) threshold or in response to the computed values taking on a negative trend, which may indicate an overall decrease in the patient's health outlook.

In block 660, recommendations may be transmitted to the patient 110 and/or one or more recipients 150 in response to the computed values or scores from block 640 crossing a specified (or computed) threshold or in response to the computed values taking on a negative trend, which may indicate an overall decrease in the patient's health outlook. The recommendations may include: sending a nurse or technician to the patient location, recommending a visit to a doctor or laboratory, recommending behavior changes (e.g., more sleep, dietary changes, more exercise), and/or recommending relocating the patient to another facility/location (e.g., discharge to home, nursing home, hospice, hospital admission, readmission, rehabilitation facility, an so forth).

In block 670, self-assessment parameters (such as patient data collection specifications 149) may be modified in response to the computed values or scores from block 640 crossing a specified (or computed) threshold or in response to the computed values taking on a negative trend which may indicate an overall failing in the patient's health outlook. Modifying the parameters may increase, decrease, or terminate patient queries 119 or the collection of patient data 120 in order to obtain addition patient information. Modifying the parameters may also change the type or frequency of patient queries 119 or the collecting of patient data 120. Modifying the parameters may also terminate one or more patient monitoring or data collection functions as a patient recovers or other changes occur.

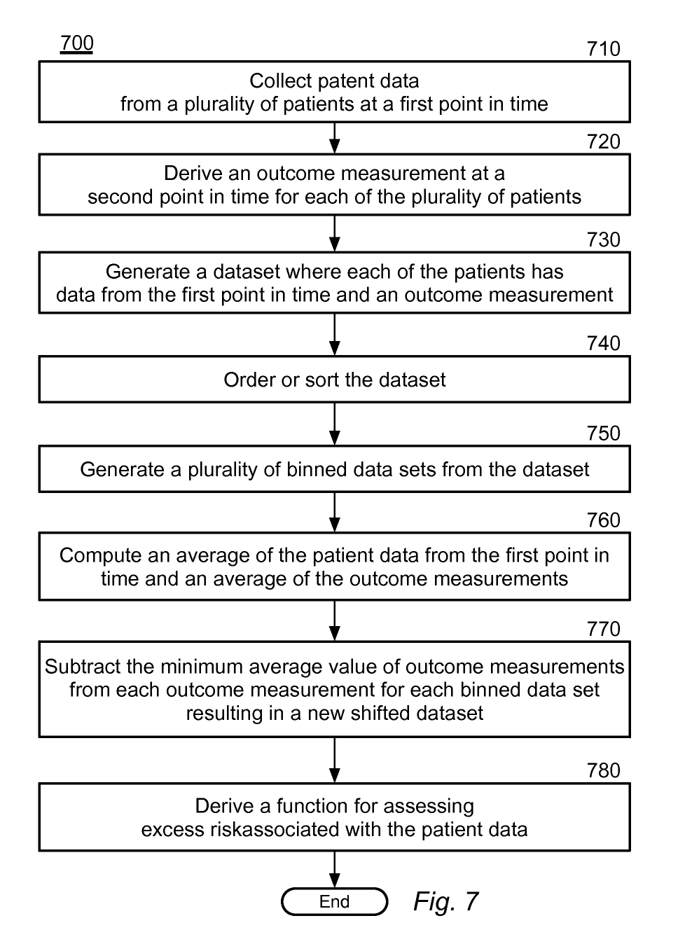

FIG. 7 is a block flow diagram depicting a method 700 for assessing risk associated with at least one type of patient data 120 due to deviation from normative values, in accordance with certain exemplary embodiments.

In block 710, patient data 120 may be collected from a plurality of patients 110 at a first point in time. The collected patient data 120 may be the same type of medical data for each of the plurality of patients 110. According to various embodiments, the first point in time can correspond to when the patient enters a stage of care (e.g., at discharge from a hospital, or entering a nursing home). According to various embodiments, the type of patient data 120 that is collected may be represented as a continuous variable, an ordinal score, a categorical class, a discretized and/or binary assessment value. According to certain embodiments, the patient data 120 may be collected from an electronic medical record (EMR). According to certain embodiments, the patient data 120 may be all or in part from self-assessed patient query responses 128. The self-assessed patient query responses 128 may be made in response to patient queries 119 that are adaptively generated by an automated health score system 130 complimented by one or more human recipients 150.

In block 720, an outcome measurement may be computed for each of the plurality of patients at a second point in time. According to certain embodiments, the outcome measurement may represent a mortality of each of the patients. For example, the mortality may be determined by reviewing death records available at the National Institute of Standards and Technology. According to certain embodiments, the outcome measurements may be determined at a second time corresponding to ninety-days post discharge. According to certain embodiments, the outcome measurements may be determined at a second time corresponding to one-year post discharge. Generally, the patient 110 will not have been discharged until the patient 110 is stable enough to be discharged safely. The patient 110 may be discharged to home or to a skilled nursing facility. Unfortunately, in some instances, the patient 110 may die. According to certain embodiments, the outcome measurement is either a “yes” or “no” answer. For example, was this patient dead one-year post discharge?

In block 730, a dataset may be generated where each of the patients has data from the first point in time and an outcome measurement from the second point in time. The dataset may be considered a set of (x,y) pairs for each patient, wherein x is the patient data 120 at the first time, and wherein y is the outcome measurement at the second time.

In block 740, the (x,y) pairs of the dataset may be ordered or sorted. In block 750, the (x,y) pairs of the dataset may be binned to form a plurality of binned data sets. According to certain embodiments, the bin size for each of the binned data sets is selected to have at least two percent of the total number of (x,y) pairs. According to certain embodiments, the (x,y) pairs are binned based on the values of x, which represents the patient data 120 from the first point in time.

In block 760, an average value (x_bar) for the patient data 120 from the first point in time (x) and an average value (y_bar) for the outcome measurements (y) may be computed. According to certain embodiments, the dataset has enough (x,y) pairs so that each bin size has a sufficient number of (x,y) pairs so that the average value for x (x_bar) and the average value for y (y_bar) are statistically significant. According to certain embodiments, the dataset has pairs (x,y) spanning the values of x that are of interest. Given that the majority of values of x will be close to the average value for x (x_bar), and given that the impact of deviations from the average are generally of great interest, the dataset may need to be large, on the order of thousands of pairs.

In block 770, the minimum average value of outcome measurements (y_bar_min) may be subtracted from each outcome measurement (y) for each binned data set resulting in a new shifted dataset. Once y_bar_min is subtracted from each outcome measurement (y), a new value of y_bar_min may be shown to be zero.

In block 780, a specific function y=f(x) may be derived for assessing excess risk associated with the patient data 120. According to certain embodiments, the function y=f(x) can define the excess risk due to deviation from normative values for the medical data. According to certain embodiments, if the type of medical data that is collected from an EMR is a continuous variable or an ordinal score, the specific function y=f(x) is a sum of a first function defined from average minimum value of x to the average maximum value of x, a second constant function that covers values of x less than x_bar_min, and a third constant function that covers values of x greater than x_bar_max. According to certain embodiments, if a value for x is greater then x_bar_max then the value of y is the value of y_bar that corresponds to the value of x_bar_max, and if a value for x is less then x_bar_min then the value of y is the value of y_bar which corresponds to the value of x_bar_min. According to certain embodiments, the first function is derived by curve fitting through the (x_bar, shifted_y_bar) points, to provide smooth interpolation between all of the x_bar_values and all of the shifted y_bar values. According to certain embodiments, the curve may not used to extrapolate beyond the highest or lowest values of x_bar. According to certain embodiments, the first function is derived by fitting an appropriate functional form. According to certain embodiments, the functional form may be selected from the group consisting of a line, a parabola, a polynomial, a sine function, and an exponential function. According to certain embodiments, the first function may be derived by fitting a higher order polynomial derived using a linear least squares method. The curve can represent the first function defined from average minimum value of x to the average maximum value of x. According to certain embodiments, the curve that is fit through the points is well-behaved, that is, the curve smoothly interpolates between all of the x_bar values and all of the new y_bar values. According to certain embodiments, if the type of data that is collected is a categorical class or a binary assessment, the function y=f(x) may be if x=“a” then y=y_bar value for just value “a.” According to certain embodiments, the function may be used in computing a health score 142 for a patient 110. According to certain embodiments, the function may be used when lab results (or similar patient data 120) are reported to a recipient 150. The function may give the recipient 150 a sense of the implications from a particular value of the medical data. According to certain embodiments, the function may be used to help researchers better understand physiology.

According to certain embodiments, it may be desirable to create a two-dimensional array from the binned data sets by associating the x_bar value for each binned data set with one axis of the two-dimensional array and associating the corresponding new y_bar value for each binned data set with a second axis of the two-dimensional array.

According to certain embodiments, the type of medical data that is collected may be a continuous variable. Examples of continuous variables may include, but are not limited to, medical data obtained from a blood chemistry panel screen, medical data relating to an arterial blood gas (ABG) test, medical data relating to a blood analysis test, and medical data measuring a vital sign value. In an embodiment, the blood chemistry panel screen includes medical data relating to an albumin/globulin (A/G) ratio, an alanine aminotransferase (ALT or SGPT) value, an aspartate aminotransferase (AST or SGOT) value, an albumin value, an alkaline phosphatase value, a blood urea nitrogen (BUN) value, a calcium value, a carbon dioxide (CO2) value, a chloride value, a creatinine value, a globulin value, a glucose value, a potassium value, a sodium value, a total bilirubin value, a total protein value and a troponin value. In an embodiment, the arterial blood gas test includes medical data relating to a base excess value, a fraction of inspired oxygen (FiO2) value, a bicarbonate (HCO3) value, a partial pressure of carbon dioxide (PCO2) value, a partial pressure of oxygen (PO2) value and a pH value. In an embodiment, the blood analysis test includes medical data relating to a hematocrit percentage, a hemoglobin value and a white blood cell count. In an embodiment, the vital sign value includes medical data relating to a heart rate value, a diastolic blood pressure value, a systolic blood pressure value, a respiration rate, a percentage of arterial hemoglobin in the oxyhemoglobin configuration (pulse Ox) and a temperature value. According to certain embodiments, the type of medical data that is collected may be an ordinal score, such as a Braden scale score.

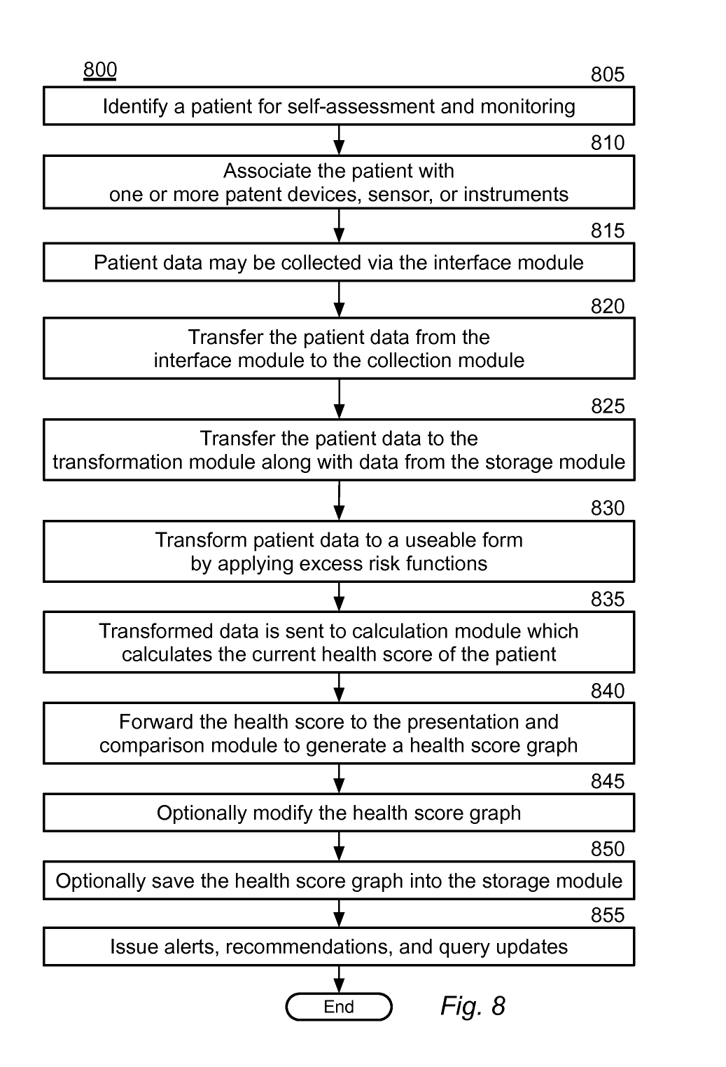

FIG. 8 is a block flow diagram depicting a method 800 for determining an overall risk associated with the current health condition of a patient 110, in accordance with certain exemplary embodiments. In block 805, a patient 110 is identified for self-assessment and monitoring. At block 810, the patient 110 can be associated with one or more patient devices 115, sensors 122, or instruments 124 for collecting patient data 120.

At block 815, the interface module 210 may begin obtaining the patient data 120 and importing the patient data 120 into the health scoring system 130. Some patient data 120 may be obtained directly from the patient 110 via patient queries 119. Other patient data 120 may be obtained from sensors 122, or medical instruments 124. Still other patient data 120 may be obtained from electronic medical records or caregiver reports 126. The patient data 120 may include any number of the medical statistics or subjective valuations that may be used to generate the health score 142.

At block 820, the data may be transferred along to the collection module 220. The collection module 220 may be coupled to the interface module 210 for receiving the various patient data 120. The collection module 220 may store the patient data 120 into the storage module 290.

At block 825, the patient data 120 may be transferred to the transformation module 240. Additionally, past patient data 210 (for example, previous health scores 142 of the patient 110) may also be collected and transferred to the transformation module 240.

According to certain embodiments, generation of one or more health scores 142 may include both subjective and objective data. Subjective data, such as self-assessments obtained through patient query responses 128, may be significant in predicting the health of the patient 110. Traditionally, clinical caregivers often overlook this information, yet its inclusion can increase the robustness of the health score 142, and may provide a channel for patients 110 to more effectively contribute to their care.

According to certain embodiments, a single term in the health score formula may contain multiple medical data inputs. For example, various pieces of patient data 120 (e.g. blood pressure, heart rate, and similar readings) may each be transformed into a particular number, which are then combined to form an over all health score 142. It should be understood, however, the multiple patient data 120 inputs may be combined before being transformed, such that the transformed number used for forming a portion of the health score, may be a combination of multiple health readings. For example, systolic and diastolic blood pressure may be combined into a single number before being transformed for use in the health score. The collection module 220 may obtain both past and present data necessary for the patient 110 on each of the categories to form one or more health scores 142.

Next, at block 830, the patient data 120 may be transformed into a usable format. The transformation module 240 may carry out the transformation such that all of the disparate forms of patient data 120 may be readily combined with one another. The transformation module 240 may be configured to transform each of the pieces of patient data 120 obtained from collection module 220 into a numerical quantity. The transformation performed by the transformation module 240 may include any number of mathematical or logical operations. Transformations may also take multiple inputs to produce a single transformed output. Multiple inputs may include historical data for the patient 110 or for any given class of patients. The transformation module 240, after receiving patient data 120 from the collection module 220, may process the data and transform it into values for use in generating one or more health scores 142 for the patient 110. The transformation module 240 may convert each piece of patient data 120 to health score values using a set of functions stored within the health score system 130. These stored functions may define excess risk due to deviation from normative values for each of the patient data 120.

At block 835, the transformed patient data 120 may combined into one or more health scores 142. The transformed patient data 120 may be transferred to the combination module 250 for combining into a health score 142 according to a predetermined algorithm. The combination module 250 may be configured to take the transformed quantities from transformation module 240, apply weighting modifiers, combine them, and then scale them onto a range, such as a score between 0 and 100. The health score 142, generated by combination module 250, may be based on the various health factors measured and transformed above, the resulting heal score 142 may thus be a relative overall health score of the patient 110 being monitored.

According to certain embodiments, weighting factors (two times, three times, and more) can be added or multiplied to certain transformed numbers as applicable to specific patient conditions. For example, respiratory factors may be weighted more heavily when a particular patient 110 is recovering from a lung-based ailment such as pneumonia. Likewise, similar weighting factors can be applied to the transformed scores of heart rate, heart rhythm, systolic and diastolic pressure for patients with heart conditions. It is understood that any number of modifications introduced into a similar combination module 250, or within the health score system 130 in general, is within the spirit and scope of the technology presented herein.

At block 840, the health score 142 may be transmitted to the presentation and/or comparison module 260. The presentation and/or comparison module 260 may use the current health score 142, as well as historical data from storage module 290 (past health scores), to generate a health score graph 144.

The presentation and/or comparison module 260 of health score system 130 may be configured to import the various data components compiled by combination module 250. This data may be used to render a health score graph 144 for the patient 110. According to certain embodiments, the presentation and/or comparison module 260 may also render a statistical reference curve on the health score graph 144. This may support, for example, the present health score 142 being easily compared to an average patient with similar conditions and circumstances. According to certain embodiments, the presentation and/or comparison module 260 may supply principal corresponding measurements of direct patient data 120 onto the health score graph 144. A smoothed health score curve may also be provided alongside the health score graph 144 to provide a running average of the health score 142 over time. The curvature of a smoothed health score graph 144 may also be provided.

Statistical reference curves may also be added to health score graph 144. For example, when such information is available, statistically computed average patient health score trajectories, for each specific procedure and initial patient condition, may be included on chart next to the health score plot. This information may be stored in the storage module 290, and may be imported into the comparison module 260 by the collection module 220. Statistical reference curves may include linear information with standard deviation error bars or transformed values. If the patient 110 is below expectation by a certain number of standard deviations, the system may generate an alert using alert module 270.

Further granularity may be provided with respect to the statistical reference curves. For example, instead of having a single reference curve for average open-heart patients of age 80, it can be further broken down by gender, and even further modified as to a patient's initial condition by using only patients with similar health scores at the time of discharge from the hospital.

Principal corresponding measurement curves may also be generated. The health score graph 144 may provide an instant context and patient health trajectory. It may also be important for recipients 150 to have access to other direct measurements, including, but not limited to, diastolic blood pressure, temperature, respiration rate, pulse, and pain score. This can support the detection of other trends that may be affecting the health score 142 and, thus, the patient 110. It should be understood that, when using the option of adding direct patient data 120 to the health score graph 144, the health score system 130 has the ability to let the healthcare provider select which principal corresponding measurements they would like to see. When the health score is improving or is adequate, such features may be toggled off, as they are less important in such instances.

According to certain embodiments, the presentation and/or comparison module 260 may be configured to alter the health score graph 144 so that when a healthcare provider detects a trend in the health score plot, they can understand exactly what factors are contributing. Accordingly, the heal score system 130 may provide for a component expansion window, such that if the patient has a health score 145 of 65 (for example), the expansion might show that the patient lost 12 points due to elevated temperature (over 101 Fahrenheit), lost 18 points due to rapid pulse (between 100 and 110 beats per minute) and lost 5 points due to a self-assessment pain score of five; all out of the perfect health score of 100.

According to certain embodiments, the presentation and/or comparison module 260 may also alter the health score graph 144 to obtain certain kinds of slope information. Even though trends may be easy to spot by eye upon looking at health score plot, an automatic “simple” slope calculation may also be useful. Mathematically, this is the first derivative of the health score as a function of time. Due to the “noisiness” of typical health score plots some averaging methods may be employed as well. If the slope is positive, the patient is probably getting better; if it is approximately zero, then the patient is staying the same; and if it is negative, then the patient may be getting worse. Slope lines may be added to the health score plot Such slope information may help identify trends in health score plot, particularly, when the plot is “noisy” due to large variations between each health score measurement.

The presentation and/or comparison module 260 of the health score system 130 may also compute “rate of change” of the simple slope. For instance, although the patient 110 may be improving, the rate of improvement may be decreasing. Such a slowing of recovery could be evidence of a problem just beginning to develop. Mathematically, this curvature information is the second derivative of the health score 142 as a function of time. Similar to the slope data, due to the “noisiness” of the curves, averaging (or smoothing) may be included in the computation.

When the patient data 120 or the health score 142 is noisy, a “running average” or other “smoothing” of the health score 142 can be displayed on health score graphs 144. The smoothed health score curve could incorporate both the first derivative (slope) and/or the second derivative (curvature) by color-coding or by thickness of the displayed line. For example, if the patient 110 was getting worse (negative slope), the line might be colored red. As other examples, if the patient is getting worse at an accelerating rate, or is getting better at a lessening rate, then the line may be bolded for emphasis.

It should be appreciated that such modifications to patient health score graphs 144 are intended only as example modification and are in no way intended to limit the scope of the present disclosure. Any similar disclosure that utilizes modified health score graphs 144 is also within the spirit and scope of the technology presented herein.

At block 845, the health score graph 144 may be modified as discussed herein. At block 850, the health score 142 or the health score graph 144 may be saved. For example, they may be save to the storage module 290. At block 855, the alert module 270 may generate an alert 146 for delivery to one or more recipient 150 as discussed herein.

### Example Systems

FIG. 9 depicts a computing machine 2000 and a module 2050 in accordance with one or more embodiments presented herein. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 also may include volatile memories, such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attachment (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (“WAN”), local area networks (“LAN”), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

One or more aspects of embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of embodiments of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A computer-implemented method for automated health monitoring, comprising:
receiving medical data associated with a patient;
issuing health queries to the patient;
receiving self-assessment data from the patient in response to the health queries;
computing a health score for the patient as a function of at least a portion of the received medical data and at least a portion of the self-assessment data;
transmitting the health score to one or more caregivers;
generating alerts in response to the health score; and
adapting future health queries in response to the health score.

2. The computer-implemented method of claim 1, wherein adapting future health queries comprises updating the type of queries to improve visibility into a particular patient condition.

3. The computer-implemented method of claim 1, wherein adapting future health queries comprises updating the frequency of queries.

4. The computer-implemented method of claim 1, wherein issuing health queries comprises an automated voice call.

5. The computer-implemented method of claim 1, wherein issuing health queries comprises a user interface of a computing machine associated with the patient.

6. The computer-implemented method of claim 1, wherein computing a health score comprises computing an excess risk value.

7. The computer-implemented method of claim 1, further comprising adapting future health queries in response to complimentary evaluation from one or more caregivers.

8. The computer-implemented method of claim 1, wherein the medical data comprises outputs from sensors or medical instruments.

9. The computer-implemented method of claim 1, wherein the patient recommendations comprise a suggestion to continue or terminate health monitoring.

10. The computer-implemented method of claim 1, wherein the patient recommendations comprise a suggestion to transition the patient from one category of care facility to another category of care facility.

11. An automated health monitoring system, comprising:
one or more processing units, and one or more processing modules, wherein the automated health monitoring system is configured by the one or more processing modules to:
receive medical data associated with a patient;
issue health queries to the patient;
receive self-assessment data from the patient in response to the health queries;
compute a health score for the patient as a function of at least a portion of the received medical data and at least a portion of the self-assessment data;
transmit the health score to one or more caregivers;
generate alerts in response to the health score;
generate patient recommendations in response to the health score; and
adapt future health queries in response to the health score.

12. The automated health monitoring system of claim 11, wherein adapting future health queries comprises updating the frequency of queries.

13. The automated health monitoring system of claim 11, wherein issuing health queries comprises an automated voice call.

14. The automated health monitoring system of claim 11, wherein issuing health queries comprises a user interface of a computing machine associated with the patient.

15. The automated health monitoring system of claim 11, wherein computing a health score comprises computing and combining two or more excess risk values.

16. The automated health monitoring system of claim 11, further comprising adapting future health queries in response to complimentary evaluation from one or more caregivers.

17. The automated health monitoring system of claim 11, wherein the medical data comprises outputs from sensors or medical instruments.

18. The automated health monitoring system of claim 11, wherein the patient recommendations comprise a suggestion to continue or terminate health monitoring.

19. The automated health monitoring system of claim 11, wherein the patient recommendations comprise a suggestion to transition the patient from one category of care facility to another category of care facility.

20. A computer program product, comprising:
a non-transitory computer-readable storage medium having computer-readable program code embodied therein that, when executed by one or more computing devices, perform a method comprising:
receiving medical data associated with a patient and comprising information from a medical instrument and information from an electronic medical record;
issuing health queries to the patient;
receiving self-assessment data from the patient in response to the health queries;
computing a health score for the patient as a function of at least a portion of the received medical data and at least a portion of the self-assessment data;
rendering a health score graph illustrating the health score over time;
annotating the heath score graph with the portion of the self-assessment data;
transmitting the health score graph to one or more caregivers; and
adapting future health queries in response to the health score.
